(19) United States
(12) Patent Application Publication
(10) Pub. No.: US 2007/0093119 A1
(43) Pub. Date: Apr. 26, 2007

(54) Housing with integrated tension relief

(76) Inventors: Peter Bruder, Ottersweier (DE); Frank Kopf, Ottersweier (DE); Parag A Athalye, Auburn Hills, MI (US); Kevin Cherry, Royal Oak, MI (US); Billy P. Hawes, Novi, MI (US)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/503,630

(22) PCT Filed: Jan. 17, 2003
(86) PCT No.: PCT/DE03/00118

§ 371 Date: Dec. 12, 2006

(30) Foreign Application Priority Data
Feb. 9, 2002 (DE) 102 05 414.2

(51) Int. Cl. H01R 13/58

(52) U.S. Cl. 439/449

(57) ABSTRACT

A housing for an electrical product having a cable for an electrical terminal includes a first housing shell and a second housing shell. A tension relief for the cable is embodied integrally with one of the two housing shells. This housing shell with the integrated tension relief is made from an electrical insulating material.

### PRIOR ART

The present invention relates to a housing for an electrical product, which has a cable for an electrical terminal.

To avoid damage, all electrical products that are connected by way of an installed cable should have a tension relief. From German Patent Disclosure DE 21 55 231, for instance, a tension-relieved cable leadthrough that extends through a wall of electrical appliances is known, in which two plastic parts are inserted into a bore in the wall and are complementary to one another in shape and which at their intersection receive the cable or individual lines. The two parts are inserted into separate housing shells of the electrical product. Then the cable is inserted, and the two housing halves are joined together in the concluding assembly operation, the cable being clamped in place by the plastic parts that meet. In this known tension relief, however, it is disadvantageous that it necessitates relatively great effort and expense for assembly and has many individual parts.

In another known tension relief, the cable is solidly molded in place as an insert part in a single plastic part. Although no other individual parts are necessary here, nevertheless embedding the cable in the plastic requires high temperature resistance of the cable insulation and makes stringent demands of the plastic. Once again, the costs are increased as a result, and moreover, to avoid damage to the cable, a rubber material is often used instead of a plastic.

### ADVANTAGES OF THE INVENTION

The tension relief of the invention for a cable of an electrical product has the advantage over the prior art that the tension relief is formed integrally in one housing shell. As a result, additional individual components can be dispensed with. For safety reasons and for the sake of simple production, the first housing shell, in which the tension relief is formed integrally, is made from an electrical insulating material.

The tension relief also has a first and second clamping jaw, between which the cable is guided. Because of this embodiment, it is possible for the cable to be lightly clamped between the two clamping jaws even before the housing is actually put together, and thus to be positioned between the clamping jaws in the correct position without additional aids or being held. The tension relief is constructed such that when the two housing shells are put together the two clamping jaws move relative to one another, in order to clamp the cable securely for the tension relief. The tension relief of the invention can thus be furnished especially inexpensively, and moreover the costs for assembly in particular are reduced, since complicated positioning and assembly of a plurality of individual components for the tension relief is unnecessary.

For the sake of an especially simple construction, the first and second clamping jaws are preferably disposed in the same plane, perpendicular to the cable course.

In another preferred feature of the present invention, the first and second clamping jaws are offset from one another in the direction of the cable course. Then the two clamping jaws are preferably disposed in different planes perpendicular to the cable course.

To assure especially simple assembly, a recess is formed in the second housing shell and has a shape corresponding to the tension relief formed integrally with the first housing shell, so that in the assembled state of the two housing shells, the clamping jaws of the tension relief are pressed together by the recess of the second housing shell so as to clamp the cable.

The second housing shell is preferably made from metal. The electrical installation is accomplished by means of the integral tension relief made from an insulating material. Especially preferably, this housing shell made from metal is a pole box of an electrical machine.

Also preferably, the first housing shell, made from an insulating material and with an integrated tension relief, is a brush holder of an electrical machine. Preferably, the housing shell made from an insulating material is made from a thermoplastic. As a result, the tension relief of the invention can be furnished especially inexpensively.

By means of the embodiment according to the invention of the tension relief with at least two clamping jaws, between which the cable is clamped, it is furthermore possible in production in an injection molding machine to dispense with so-called pushers that are otherwise necessary in the production of plastic parts with undercutting. Since according to the invention, however, no undercuts for the tension relief are necessary, these pushers can accordingly be dispensed with. Thus the tool costs for producing the housing shell with an integrated tension relief can be lowered as well.

Furthermore, in the integrated tension relief according to the invention, threading the cable into the reassembled tension relief can be made easier. To that end, the cable can be guided between the two clamping jaws of the tension relief and prestressed by the two clamping jaws until it is connected electrically, for instance by means of welding, soldering, crimping, plugging-in, and so forth. For guiding the cable, contact points where the clamping jaws touch the cable are lengthened in tublike fashion in the direction of the cable course. In order here to avoid the aforementioned pushers in the production process, it can be provided that the tublike bulges can be formed on in offset fashion. Prestressing for the cable occurs if the tublike guide tapers downstream of the first threading-in site. As soon as the guide cross section becomes smaller than the cable cross section, a slight stressing occurs, so that the cable is temporarily fixed and can be connected without problems.

An assembly with the integrated, one-piece tension relief of the invention can thus be performed such that first the two housing shells are made, and then the cable is guided into the integrated tension relief, that is, threaded through between the clamping jaws, and then contacted electrically, and finally the second housing shell is put on top. During this process, clamping of the cable takes place in the tension relief, so that the cable is installed in secured fashion.

It should be noted that according to the invention, the term “cable” should be understood to mean either an individual line or a cable with a plurality of individual lines.

### DRAWINGS

Two exemplary embodiments of the invention are described in further detail in the ensuing description. Shown are:

FIG. 1, a perspective view of a housing with an integrated tension relief in accordance with a first exemplary embodiment of the present invention;

FIG. 2, a schematic, enlarged side view of the tension relief of the first exemplary embodiment before assembly;

FIG. 3, a sectional view taken along the line A-A of FIG. 2, showing the tension relief in the assembled state;

FIG. 4, a side view of a housing with an integrated tension relief in a second exemplary embodiment of the present invention, before assembly; and

FIG. 5, a sectional view taken along the line B-B of FIG. 4 of the housing in the second exemplary embodiment, in the assembled state.

### DESCRIPTION OF THE EXEMPLARY EMBODIMENTS

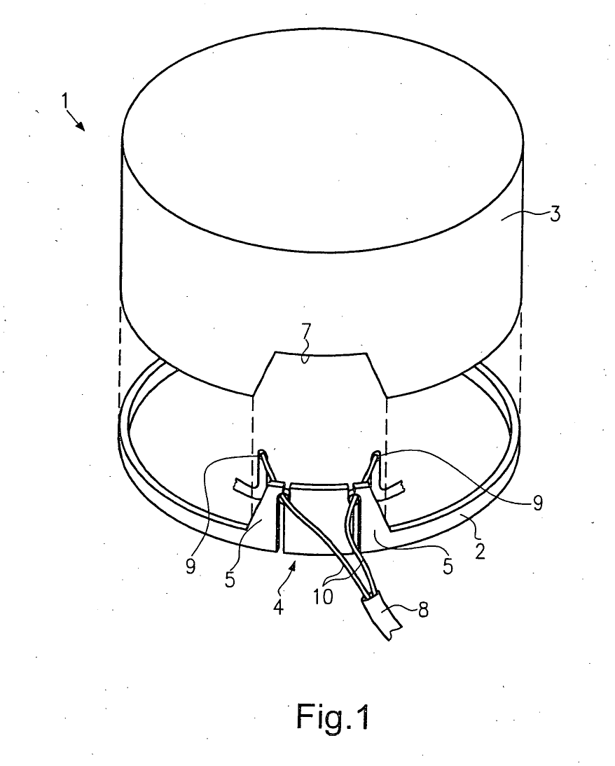

A housing 1 with an integrated tension relief 4 will now be described, referring to FIGS. 1-3.

As can be seen particularly from FIG. 1, the housing 1 comprises a first housing shell or housing half 2 and a second housing shell or housing half 3. The tension relief 4 is embodied integrally in the first housing shell 2.

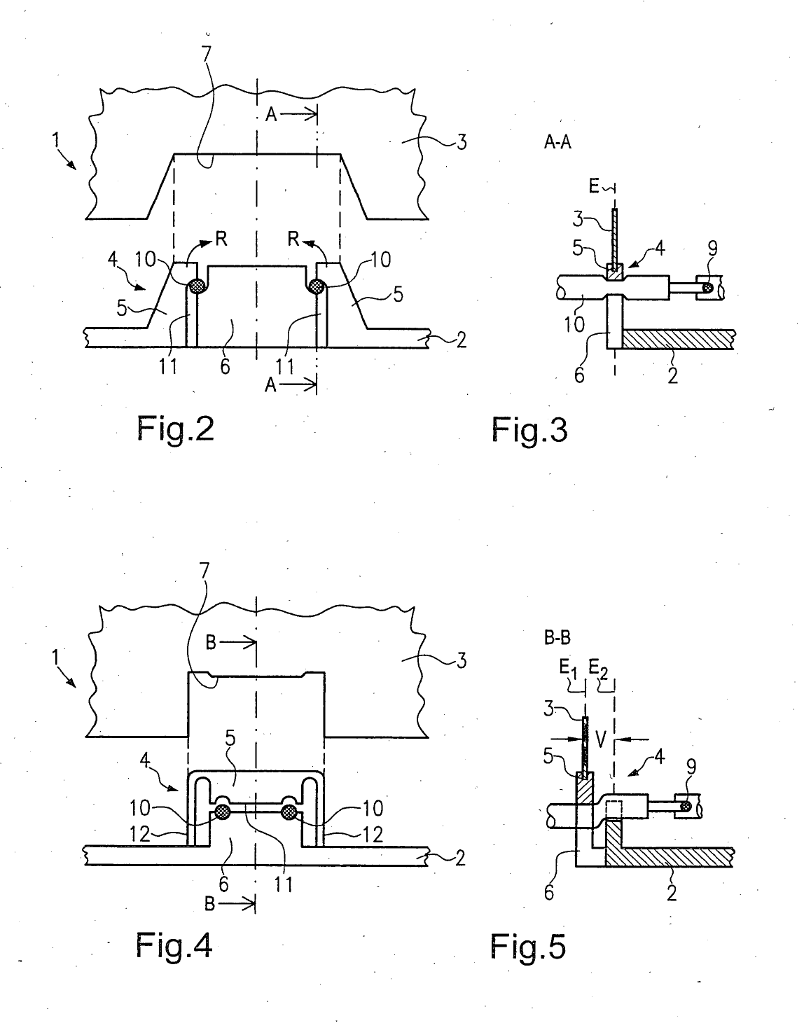

The tension relief 4 is shown in more detail in FIGS. 2 and 3. As shown, the tension relief 4 includes a first clamping jaw 5 and a second clamping jaw 6. The two clamping jaws 5, 6 are embodied such that between them there is a slitlike interstice 11, in which the cable is disposed. It should be noted that in this exemplary embodiment, two lines 10 are provided, which are guided jointly in a cable 8 by means of an insulation (see FIG. 1). As FIG. 2 shows, there is therefore a first clamping jaw 5 both on the left and on the right of the second clamping jaw, each for clamping a separate line 10 and relieving it from tension. As seen particularly in FIG. 3, the first clamping jaw 5 and the second clamping jaw 6 are disposed in a plane E-E perpendicular to the cable course through the housing.

As can also be seen from FIG. 3, the line 10 is connected to an electrical terminal 9 of the electrical product that is surrounded by the housing 1. The electrical products shown in FIGS. 1-3 are an electrical machine, and the housing shell 3 is made from metal and serves as a pole box for the electrical machine. The first housing shell 2 is made of an electrical insulating material, such as a plastic. As a result, it is possible for the tension relief 4, integrated in the first housing shell 2, to be made in one piece with the first housing shell 2, for instance by means of injection molding.

As seen particularly from FIG. 2, the first clamping jaws 5 of the tension relief 4 are partly elastic, so that the cable 10 disposed in the slitlike recess 11 is already held lightly before the second housing shell 3 is put on top.

As shown in FIG. 2, in the second housing shell 3 a recess 7 is formed, which corresponds to the outer contour of the tension relief 4. As seen from FIG. 2, the two first clamping jaws 5 are embodied such that they taper in the direction of the second housing shell 3. When the second housing shell 3 is now placed on top of the first housing shell 2, the two first clamping jaws 5, because of their elasticity, press inward in the direction of the arrows R against the second clamping jaw 6. As a result, the line 10 is firmly clamped in place between the two clamping jaws 5, 6 (see FIG. 3), so that the line 10 is secured against being disconnected from the terminal 9 by tensile stress.

The tension relief 4 formed integrally in the first housing shell 2 withstands repeated disassembly of the two housing shells 2, 3 and can be reused multiple times, since it is not destroyed when the two housing shells are disassembled.

The housing 1 shown in the first exemplary embodiment can be used especially advantageous in electrical machines, and in particular electric motors, such as small motors for components of motor vehicles.

The tension relief 4 formed integrally in the first housing shell 2 can form one part of the outer wall of the housing 1. It should be noted that even though the first housing shell 2 has a lidlike shape, the housing shell 2 can have some other shape instead.

A housing 1 in a second exemplary embodiment of the present invention will now be described, referring to FIGS. 4-5. Parts that are the same or functionally the same are identified by the same reference numerals as in the first exemplary embodiment.

As shown in FIG. 4, in the first exemplary embodiment the tension relief 4 is formed integrally on the first housing shell 2. Once again, the tension relief 4 includes a first clamping jaw 5 and a second clamping jaw 6. Between these two clamping jaws 5, 6, a gap 11 is formed. The spacing between the two clamping jaws 5, 6 is greater than the diameter of the line 10. As shown in FIG. 5, in contrast to the first exemplary embodiment, in the second exemplary embodiment the first clamping jaw 5 is disposed in a first plane E₁, and the second clamping jaw 6 is disposed in a second plane E₂. The two planes E₁ and E₂ are parallel to one another with an offset V between them (see FIG. 5).

When the second housing shell 3, with the recess 7 formed to fit the tension relief 4, is placed on the first housing shell 2, the recess 7 comes into contact with the first clamping jaw 5 and presses it downward. As a result, the ribs 12 formed on the two sides of the first clamping jaw 5 are bent elastically, so that the first clamping jaw 5 presses the two lines 10 downward somewhat (see FIG. 5). Once the two housing shells 2 and 3 are joined completely to one another, the line 10 thus has a slightly S-shaped course (see FIG. 5). Clamping of the line 10 between the first clamping jaw 5 and the second clamping jaw 6 is thus made possible. Because of the offset disposition of the two clamping jaws 5, 6, it is moreover possible for the first housing shell 2 to be produced in a single operation as a plastic part without a pusher. Also because of the flexible design of the ribs 12 of the first clamping jaw 5, the housing can be disassembled again without damage, so that the tension relief 4 releases the clamping of the line 10, for instance so that the line 10 can be replaced. After that, the housing shells 2, 3 can be put together once again, and the tension relief 4 then again clamps the newly inserted line 10.

It should be noted that the two housings 1 shown are preferably used as a housing for electrical machines, such as electric motors for components of motor vehicles, such as engine cooling fans or the like. To that end, the second housing shell 3 is made from metal and besides its function as a housing also has the function of a pole box for the electric motor.

The present invention thus relates to a housing 1 for an electrical product that has a cable 8, 10 for an electrical terminal 9. The housing 1 includes a first housing shell 2 and a second housing shell 3. A tension relief 4 for the cable 8, 10 is also provided and is formed integrally with one of the two housing shells. This housing shell 2 with the integrated tension relief 4 is made from an electrical insulating material.

The above description of the exemplary embodiments of the present invention is intended solely for the sake of illustration and not for the sake of limiting the invention. Within the scope of the invention, various changes and modifications may be made without departing from the scope of the invention or its equivalents.

1-8. (canceled)

9. A housing for an electrical machine having a cable (10) for an electrical terminal (9), the housing comprising
a first housing shell (2)
a second housing shell (3),
a tension relief (4) for the cable (8, 10) is embodied integrally with the first housing shell (2), and the first housing shell (2) being produced of an electrically insulating material, and
the tension relief (4) having a first clamping jaw (5) and a second clamping jaw (6), between which the cable (8, 10) is guided, the tension relief (4) being constructed in such a way that when the two housing shells (2, 3) are put together, the two clamping jaws (5, 6) are moved relative to one another in order to clamp the cable (8, 10).

10. The housing of claim 9, wherein the first and second clamping jaws (5, 6) are located in the same plane (E) perpendicular to the cable course.

11. The housing of claim 9, wherein the first and second clamping jaws (5, 6) are disposed in the direction of the cable course in two parallel planes (E₁, E₂) offset from one another and disposed perpendicular to the cable course.

12. The housing of claim 10, wherein the first and second clamping jaws (5, 6) are disposed in the direction of the cable course in two parallel planes (E₁, E₂) offset from one another and disposed perpendicular to the cable course.

13. The housing of claim 9, further comprising a recess (7) formed in the second housing shell (3), which recess in the installed state exerts a force on the two clamping jaws (5, 6) for clamping the cable (10).

14. The housing of claim 10, further comprising a recess (7) formed in the second housing shell (3), which recess in the installed state exerts a force on the two clamping jaws (5, 6) for clamping the cable (10).

15. The housing of claim 11, further comprising a recess (7) formed in the second housing shell (3), which recess in the installed state exerts a force on the two clamping jaws (5, 6) for clamping the cable (10).

16. The housing of claim 9, wherein the second housing shell (3) is made from metal.

17. The housing of claim 10, wherein the second housing shell (3) is made from metal.

18. The housing of claim 11, wherein the second housing shell (3) is made from metal.

19. The housing of claim 13, wherein the second housing shell (3) is made from metal.

20. The housing of claim 16, wherein the housing shell (3) made from metal is a pole box of an electrical machine.

21. The housing of claim 9, wherein the first housing shell (2), made from an electrical insulating material, is a brush holder of an electrical machine.

22. The housing of claim 13, wherein the first housing shell (2), made from an electrical insulating material, is a brush holder of an electrical machine.

23. The housing of claim 16, wherein the first housing shell (2), made from an electrical insulating material, is a brush holder of an electrical machine.

24. The housing of claim 20, wherein the first housing shell (2), made from an electrical insulating material, is a brush holder of an electrical machine.

25. The housing of claim 9, wherein the first housing shell (2), made from an electrical insulating material, is made from a thermoplastic.

26. The housing of claim 21, wherein the first housing shell (2), made from an electrical insulating material, is made from a thermoplastic.
